(19) United States
(12) Patent Application Publication
(10) Pub. No.: US 2024/0329851 A1
(43) Pub. Date: Oct. 3, 2024

(54) METHOD AND DATA PROCESSING APPARATUS FOR RESTRUCTURING INPUT DATA TO BE STORED IN A MULTI-LEVEL NAND FLASH MEMORY

(71) Applicant: Hyperstone GmbH, Konstanz (DE)

(72) Inventor: Sami ALSALAMIN, Eggenstein-Leopoldshafen (DE)

(73) Assignee: Hyperstone GmbH, Konstanz (DE)

(21) Appl. No.: 18/625,941

(22) Filed: Apr. 3, 2024

(30) Foreign Application Priority Data
Apr. 3, 2023 (DE) 10 2023 108 499.2

(51) Int. Cl. G06F 3/06

(52) U.S. Cl. CPC G06F 3/0616; G06F 3/0644; G06F 3/0679

(57) ABSTRACT

Provided is a method and a data processing apparatus for restructuring input data to be stored in a flash memory having a plurality of multi-level flash memory cells. The method comprises: based on a defined page structure according to which the input data is segmented into multiple logical input pages, restructuring the segmented input data to obtain corresponding output data being segmented into logical output pages, wherein each output page has one or more associated destination data pages for storing content of the output page therein; and outputting the segmented output data for storage to the flash memory in accordance with the associations between the output pages and their respective destination data pages. The restructuring comprises assigning to each output page a respective corresponding input page, and selecting the respective input page for assignment to the respective output page.

### CROSS REFERENCE TO RELATED APPLICATIONS

The present application claims priority to German Patent Application No. 10 2023 108 499.2, filed Apr. 3, 2023. The entirety of the aforementioned patent application is hereby incorporated by reference in its entirety for all purposes.

### TECHNICAL FIELD

Embodiments of the present disclosure relate to the field of flash memory technology. Specifically, it is directed to a method and an apparatus for restructuring, i.e., rearranging or modifying or both, input data to be stored in a NAND flash memory having a plurality of multi-level flash memory cells being arranged in multiple physical pages, each having a defined number N>1 of data pages corresponding to the different levels of the multi-level flash memory. The NAND flash memory may particularly comprise one or more flash memory components, such as semiconductor-based memory chips.

### BACKGROUND

Flash memory, particularly NAND flash memory, is one of the most popular data storage solutions, which has become more prominent in almost all modern electronic devices with storage capability demands, ranging from wearable devices to enterprise servers. The ever-increasing cost efficiency, non-volatile increasing capacity, decent performance, and mechanical shock resistance of flash memory mainly drive such popularity. Flash memory manufacturers have particularly been scaling NAND flash cells into smaller semiconductor technology nodes to cope with the increasing demands for high capacity, improve performance, and reduce the cost of flash memory. Inherently, NAND flash technology is an error-prone technology, and hence, its reliability is subject to continuous supervision, correction, and optimization. With increasing flash density, NAND flash memory cells generally become more susceptible to different error types and circuit-level noises, degrading their reliability and endurance. For instance, the write-erase (W/E) cycles typically cause gradual permanent damage inside the NAND flash cells, degrading their reliability over time and limiting the NAND flash memory's lifetime (i.e., endurance).

### BRIEF SUMMARY

It is an object of the present disclosure to improve further the achievable reliability and/or lifetime of flash memory devices, including particularly 3D NAND flash memory devices.

A solution to this problem is provided by the teaching of the independent claims. Various preferred embodiments of the present solution are provided by the teachings of the dependent claims.

A first aspect of the present solution is directed to a method, which may particularly be a computer-implemented method, of restructuring input data to be stored in a NAND flash memory having a plurality of multi-level flash memory cells (i.e., MLC cells) being arranged in multiple physical pages, each having a defined number N>1 of data pages corresponding to the different levels of the multi-level flash memory.

The method, which may particularly be performed by a flash memory controller, comprises:
a) based on a defined page structure according to which the input data is segmented into multiple logical input pages, restructuring the segmented input data to obtain corresponding output data being segmented into logical output pages, wherein each output page has one or more associated destination data pages for storing content of the output page therein; and
b) outputting the segmented output data for storage to the flash memory in accordance with the associations between the output pages and their respective destination data pages.

The restructuring comprises assigning to each output page a respective corresponding input page and selecting the respective input page for assignment to the respective output page based on: (i) the level of the one or more destination data pages being associated with the output page, (ii) the content of the input page, and (iii) a memory reliability optimization goal being defined as a function of the level of the one or more destination data pages being associated with the output page.

### BRIEF DESCRIPTION OF THE DRAWINGS

Further advantages, features, and applications of the present solution are provided in the following detailed description and the appended figures, wherein:

FIG. 1 schematically illustrates various flash technologies with different numbers of levels;

FIG. 2 schematically illustrates an exemplary 3D NAND flash memory block;

FIG. 3 shows models of in its sub-figure (a) states of TLC flash cells and their 3-bit binary data representations (encoding), in its sub-figures (b) and (c) examples of threshold voltage distributions of two different flash technologies, and in its sub-figure (d) a chart to illustrate an exemplary typical dependency of the required voltage and time to program flash cells on different states;

FIGS. 4A and 4B collectively show six different exemplary synthetic data pattern distributions for a TLC NAND Flash memory; specifically, these figures each show a different byte distribution of a sequence of data within a page having three data pages corresponding to the three levels of the TLC flash memory;

FIG. 5 shows a histogram of the synthetic data patterns of FIGS. 4A and 4B, wherein the density is normalized to the size of page in byte, e.g., 18336 Bytes;

FIG. 6 shows an exemplary EBC over data retention of DP's pages normalized to DP2 maximum EBC. For visualization, EBC is selected as the maximum EBC of the three pages, i.e., EBC=MaxEBC (LSP, CSP, MSP);

FIG. 7 shows exemplary page contents regions with three different optimization constraints/goals;

FIG. 8 illustrates an exemplary masking process for inverting frames (i.e., portions) of the page;

FIG. 9 shows, in pseudocode, an exemplary embodiment of a method of restructuring input data to be stored in a multi-level NAND flash memory, according to the present solution;

FIG. 10 shows an exemplary process flow for restructuring input data to be stored in a multi-level NAND flash memory according to the present solution an examination of the results of an optimization achieved by the restructuring; and

FIG. 11 shows exemplary results for the EBC of (a) data-unaware (DU) and (b) data-aware (DA) scenarios under the W/E cycles=1000 of the three-page types, EBC normalized to the maximum value of (a), which very obtained using the method of FIG. 10 in combination with the method of FIG. 9 for the data-aware (DA) optimization; and

FIG. 12 schematically illustrates an exemplary data processing apparatus for performing the method in the form of a memory controller within a memory system.

### DETAILED DESCRIPTION

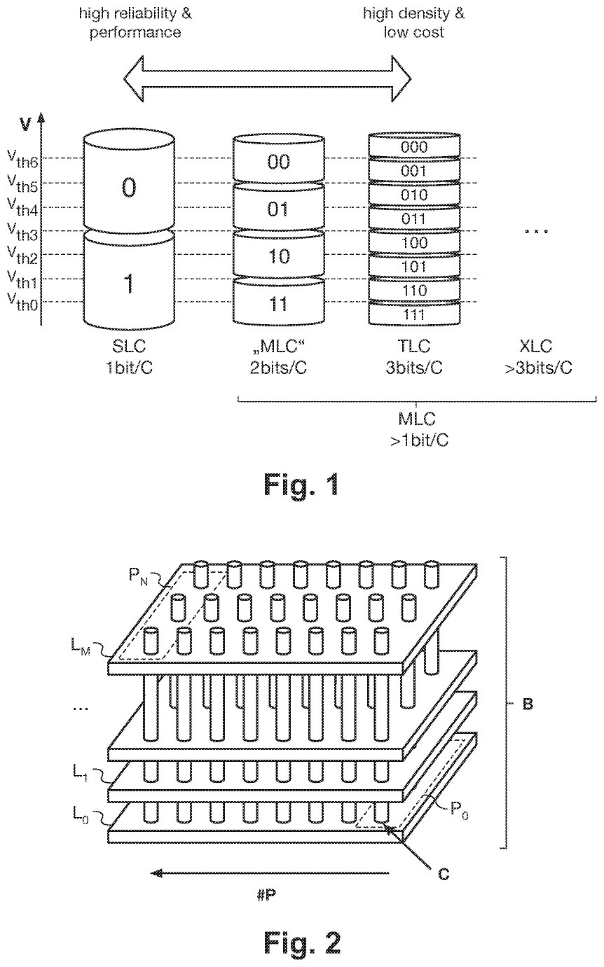

In a NAND flash cell, stored data is represented by the amount of electrical charge stored within a storage transistor, i.e., floating gate (FG) or charge trap (CT) transistor. Initially, NAND flash cells, known as single-level cells (SLC), could only store one bit of data per cell. However, to increase storage density, flash manufacturers turned to using multi-level cells (MLC) that can store multiple bits of data per cell, thereby multiplying (e.g., doubling, tripling or quadrupling) storage capacity while using the same physical flash memory device, such as a semiconductor chip. Nowadays, technologies commonly use Single-Level cell (SLC), dual-level cell, or Triple-Level Cell (TLC) NAND flashes. Each type has unique characteristics and applications, as will be discussed in more detail below in connection with FIG. 1.

It is noted that while in the electronics industry, it is rather common to refer to dual-level cells-somewhat inconsistently with the above co-existing more general definition of MLC—as “Multiple-Level Cells” or “Multi-level Cells”, we adopt herein the above more general definition according to which the terms “Multiple-Level Cell”, “Multi-level Cell” and “MLC” each refer to cells of a NAND flash memory that stores multiple bits of data per cell instead of only a single bit as in SLC.

Due to the programming technique and the nature of the charge leaking directly after programming, slightly different charges can represent the same stored logical data. Therefore, in MLC memory cells, the stored logical data is represented by a threshold voltage (Vth) range, defining the minimal voltage required to turn on the transistor (i.e., storing cell) based on the stored charge of the cell's threshold voltage, as will also be discussed in more detail below in connection in FIG. 1. However, the threshold voltage range used to represent each logical value becomes even smaller in MLC, thus typically increasing the error rates for determining the correct logical representation stored within the cell (i.e., reducing the probability that stored data will be read correctly).

Conventional NAND flash memory has a planar (2D) architecture, where the entire memory cell set is laterally arranged in a single plane. However, the increasing demand for high-density, non-volatile memory devices has pushed flash manufacturers to switch to a 3D flash structure instead of a planar flash structure.

Nowadays, planar NAND flash memory usually uses a technology node of 20 nm to 15 nm, and future generations will likely use even smaller nodes. Scaling down the flash cell further while maintaining reliability was a significant challenge for flash manufacturers. 3D NAND flash memory has been introduced to overcome the aforementioned issues. Unlike planar NAND flash memory, 3D NAND flash uses vertically stacked flash cells in a 3D structure, as will be discussed in more detail below in connection in FIG. 2. This, in turn, enables flash manufacturers to increase the storage density while using larger technology nodes than for planar NAND flash memory, and hence maintain a high flash memory reliability. However, circuitry and structural changes introduced by 3D NAND flash memory technology significantly vary error sources that impact reliability. For instance, new reliability threats become critical, e.g., layer-to-layer variations and cell-to-cell interferences generally become particularly relevant error sources of 3D NAND flash.

Different phenomena affect the NAND flash reliability, disturbing stored data and reducing flash memory devices' lifetime. NAND flash is inherently error-prone, as the stored charge is changed for various reasons. This could result in reliability threats, such as data retention, cell interference, and cell degradation. These threats typically apply concurrently, which can severely worsen the reliability of the NAND flash if countermeasures are not considered. Correction mechanisms (e.g., error correction code (ECC)), therefore, are always required to maintain reliability and secure the stored data. Correction capabilities are limited to the employed algorithm, and increasing such capability is very costly. Advanced correction mechanisms are used to improve the correction capabilities at an acceptable cost. However, modern memory devices employ advanced mitigation mechanisms to reduce the impacts of reliability threats, keeping the error rates at an acceptable level and maintaining reliability.

Even though the advent of 3D NAND flash memory has generally improved reliability over planar 2D NAND flash memory, it brought new reliability threats to the scene. Nowadays, maintaining reliability while utilizing a long lifetime in high-density NAND flash memory devices is still challenging. However, while the reliability threats are typically concurrent phenomena, they usually share similar implications and roots. The stored charge (i.e., data) is the primary factor influencing the reliability and lifetime of the NAND flash cell. It can alleviate or intensify specific reliability issues to some extent. For instance, a good distribution of charges among neighboring cells can decrease cell-to-cell interference. Additionally, sustaining flash cells in good conditions by minimizing internal degradation is crucial for preserving their reliability and extending their lifetime, which is also influenced by the stored charge level.

It is an object of the present disclosure to improve further the achievable reliability and/or lifetime of flash memory devices, including particularly 3D NAND flash memory devices.

A solution to this problem is provided by the teaching of the independent claims. Various preferred embodiments of the present solution are provided by the teachings of the dependent claims.

A first aspect of the present solution is directed to a method, which may particularly be a computer-implemented method, of restructuring input data to be stored in a NAND flash memory having a plurality of multi-level flash memory cells (i.e., MLC cells) being arranged in multiple physical pages, each having a defined number N>1 of data pages corresponding to the different levels of the multi-level flash memory.

The method, which may particularly be performed by a flash memory controller, comprises:
a) based on a defined page structure according to which the input data is segmented into multiple logical input pages, restructuring the segmented input data to obtain corresponding output data being segmented into logical output pages, wherein each output page has one or more associated destination data pages for storing content of the output page therein; and
b) outputting the segmented output data for storage to the flash memory in accordance with the associations between the output pages and their respective destination data pages.

The restructuring comprises assigning to each output page a respective corresponding input page and selecting the respective input page for assignment to the respective output page based on: (i) the level of the one or more destination data pages being associated with the output page, (ii) the content of the input page, and (iii) a memory reliability optimization goal being defined as a function of the level of the one or more destination data pages being associated with the output page.

The input page is selected so that it or a reversibly transformed version thereof satisfies the memory reliability optimization goal associated with the output page's associated destination data page, and the content of the output page is defined accordingly as that of the input page or its reversibly transformed version, respectively.

The term “flash memory device” or “memory device” in short, as used herein, refers to a physical device that comprises flash memory. Particularly, a flash memory component, such as a flash memory chip, a higher-integrated system, such as a flash memory stick or card, or an SSD storage of a computer are all examples of flash memory devices.

The term “physical page” as used herein, refers to a physical realization of a unit of data storage in a flash memory device, which is the smallest amount of data that can be written or read independently in the flash memory device, particularly in a flash memory component. The size of a physical page may vary depending on the type and manufacturer of the flash memory device. Currently, the size is typically on the order of kilobytes (KB) to several hundred kilobytes (KB). A physical page is made up of a fixed number of bytes, which can range from 128 bytes in some small flash memories to several megabytes (MB) or even more in larger ones. The number of physical pages in a flash memory device is typically limited by the size of the device and the capacity of the memory cells within it. Each page in a flash memory device typically has its own unique address, which is used to locate the page within the device. The addresses are usually assigned sequentially, with each page having a unique address that increases as more pages are added to the device. In a typical NAND flash memory design, all flash memory cells belonging to a same physical page share a same word line which is connected to and thereby interconnects the control gates of these memory cells.

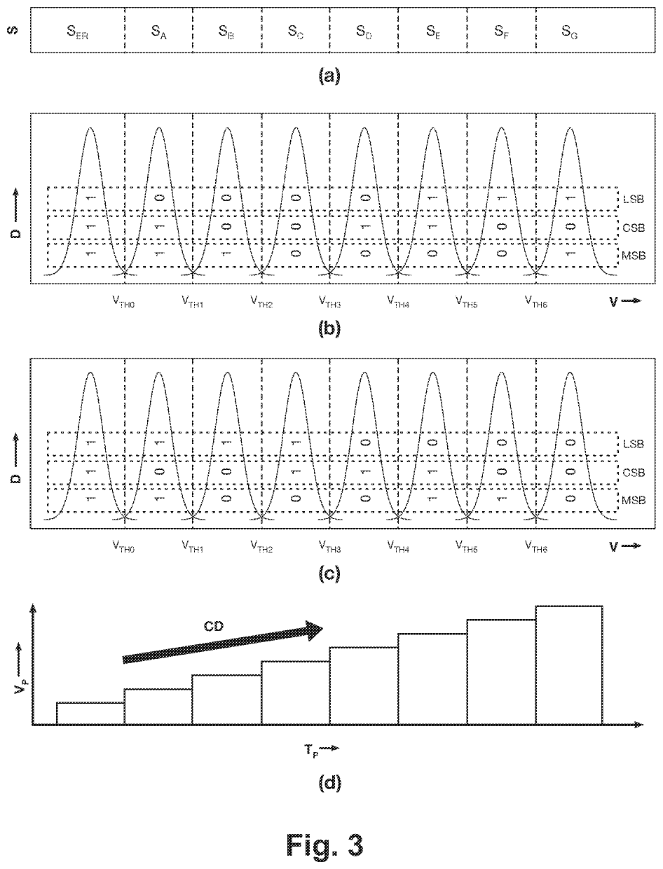

The term “data page” as used herein, refers to a smaller unit of data storage within a larger physical page in a multi-level flash memory cell. In other words, a data page is a subset of a page that contains a portion of the total data stored in the physical page. The size of a data page can vary depending on the type and manufacturer of the flash memory device, but it is typically in the order of hundreds of bytes to several kilobytes (KB). The concept of data pages is used in multi-level cell (MLC) flash memories to increase storage density. In MLC flash memories, each physical page can store data in multiple levels, i.e., in multiple data pages, the levels corresponding to the different bit levels of the memory cells in the physical page. For example, in a TLC flash memory device with three levels of data storage (L0-L2), each physical page can store data from any of these three levels. These levels correspond to three bit-levels, which are usually denoted as most significant bit (MSB), center significant Bit (CSB), and least significant bit (LSB), respectively, as will be discussed in more detail further below in connection with FIG. 3. Similarly, the data pages of a TLC flash, which correspond to the three bit-levels are usually denoted as most significant page (MSP), center significant page (CSP) and least significant page (LSP), respectively,

The term “destination data page” as used herein, refers to a data page being selected as a destination for a storage of at least a part of the content of an output page associated with this data page. Similarly, the term “destination page” as used herein, refers to a physical page to which the destination data page pertains.

The term “page structure”, as used herein, refers to a defined physical or logical structure according to which a set of data is structured into multiple data segments, which may particularly have a same size. For example, in the case of a physical structure, a page structure may be a physical array of memory cells into which data to be structured is loaded and where either the rows or the columns of the array define the segments, so that all data items of a same row (or column) belong to a same segment. In contrast, data items of different rows (or columns) belong to corresponding different segments. In another example, in the case of a logical structure, a page structure may be defined so that a set of data being organized according to a linear address range is logically divided into segments, each having the same defined page size m (i.e., m bits per page), so that every m bits in the range a new page begins.

The term “logical page”, as used herein, refers to a unit of data storage that is defined by the user or application, rather than being determined by the physical structure of the memory device. Logical pages may be larger than the physical pages of the flash memory and typically range in size from a few kilobytes to several megabytes (MB). A logical page typically consists of a contiguous block of data, which can be located across one or more physical pages, particularly their data pages of a same level, within the flash memory device. The number of physical pages needed to store a logical page can vary depending on the type and manufacturer of the flash memory device, as well as the specific application or user requirements.

The term “logical input page” or “input page” in short, as used herein, refers to a logical page (such as a data segment of a larger set of data) provided as part of the input data to be processed in accordance with the method to prepare the logical page for a later storage to a flash memory, e.g., to a same physical page of more particularly to a same data page thereof.

The term “logical output page” or “output page” in short, as used herein, refers to a logical page (such as a data segment of a larger set of data) which results from carrying out the method and which is to be stored to a flash memory, e.g., to a same physical page of more particularly to a same data page thereof.

The terms “memory reliability optimization goal” or “optimization goal” in short, as used herein, can be used interchangeably and refer to one or more defined conditions, the satisfaction of which is positively correlated to the reliability of the flash memory, particularly to a reduction of its degradation (typically caused by gradual degradation of the memory cells), or an increase in its lifetime. A memory reliability optimization goal may particularly be defined based on an assignment scheme of the flash memory, according to which assignment scheme different logical data representations of the flash memory cells are assigned to respective different threshold voltages of the flash memory cells of the flash memory. Thus, the memory reliability optimization goals may depend on the specific type of flash memory in relation to which the method is performed. The one or more conditions may particularly be defined in a quantifiable manner so that a degree of satisfaction below or above a threshold at which the condition becomes satisfied can be quantified. For example, if in the case of a single condition, the condition is defined so that it is satisfied if a number of bits of (logical) value “1” (one) in a bit pattern is higher than a threshold value k, then for a given bit pattern, e.g., an input page, its associated degree of satisfaction of the condition may be defined as a mathematical difference between the actual number n of bits of value “1” in the bit pattern and the threshold value k, i.e., as n-k. The term “optimization constraint” is used further below in to refer to such threshold values k, which can be used to define the optimization goals (see optimization constraints O_{TH} and Z_{TH}).

The terms “first”, “second”, “third” and the like in the description and in the claims, are used for distinguishing between similar elements and not necessarily for describing a sequential or chronological order. It is to be understood that the terms so used are interchangeable under appropriate circumstances, and that the embodiments of the present solution described herein are capable of operation in other sequences than described or illustrated herein.

Unless the context requires otherwise, where the term “comprising” or “including” or a variation thereof, such as “comprises” or “comprise” or “include”, is used in the present description and claims, it does not exclude other elements or steps and is to be construed in an open, inclusive sense, that is, as “including but not limited to”.

Where an indefinite or definite article is used when referring to a singular noun e.g., “a” or “an”, “the”, this includes a plural of that noun unless something else is specifically stated.

Appearances of the phrases “in some embodiments”, “in one embodiment” or “in an embodiment”, if any, in the description are not necessarily all referring to the same embodiment. Furthermore, the particular features, structures, or characteristics may be combined in any suitable manner in one or more embodiments.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

By the terms “configured” or “arranged” to perform a particular function, (and respective variations thereof) as they may be used herein, it is to be understood that a relevant device or component is already in a configuration or setting in which it can perform the function, or it is at least adjustable—i.e., configurable—in such a way that it can perform the function after appropriate adjustment. In this context, the configuration can be carried out, for example, through a corresponding setting of parameters of a process sequence or of hardware (HW) or software (SW) or combined HW/SW-switches or the like for activating or deactivating functionalities or settings. In particular, the device may have a plurality of predetermined configurations or operating modes, so that the configuration can be performed through a selection of one of these configurations or operating modes.

Accordingly, the method of the first aspect may be used to restructure, i.e., rearrange and/or transform the input data, namely its input pages, before its/their storage to the flash memory in a data-aware manner, such that based on the respective content of the input pages an optimized assignment of the input pages to output pages and hence to the output pages' associated destination data pages is determined in view of the memory reliability optimization goal associated therewith. Accordingly, based on the restructuring, an improved match between the input pages' respective content and the physical constraints of the data pages, as defined in the respectively associated memory reliability optimization goal can be achieved, and thus, stress for the flash memory decreased. For example, a particular first data page may be less stress-resistant when loaded with a bit pattern having a majority of bits of bit value “1” than when loaded with a bit pattern having a majority of bits of bit value “0” (also the location of the “1” or “0” values within the bit pattern may matter in this regard), while for second data page the opposite is true.

Then, according to the method, a given input page with a majority of bits of bit value “0” can be advantageously assigned to an output page associated with the second data page rather than the first data page. In this way, the stress level for the flash memory cells can be mitigated and the lifetime of the flash memory can be extended.

Typically, due to the physical design of flash memory cells, those bit representations which according to the associated assignment scheme of the flash memory require higher charges for their storage and thus longer writing times for their writing and higher threshold voltages for their reading from the flash memory are more prone to causing high stress, esp. on tunnel oxides of the affected memory cells, than bit representations that require respective lower voltages. Accordingly, the method may be considered as an optimization method that selects for given input pages (via assignment to output pages) suitable associated data pages for storing them, wherein the selection is based on the content of the input pages, the technology of the flash memory (particularly its assignment scheme), and the data page type (i.e., its level). The method tries to restructure the input data in such a manner that charging states of the flash cells belonging to the low-voltage side of the Vth distribution, i.e., lower Vth states, are used for the storage as much as possible, while higher Vth states are avoided, as much as possible.

Accordingly, the method may particularly serve to suppress the ever-increasing error rates and improve the longevity of multi-level NAND flash memory, such as TLC 3D NAND flash memory, without limitations.

In the following, preferred embodiments of the method of the first aspect are described, which can be arbitrarily combined with each other or with other aspects of the present solution, unless such combination is explicitly excluded or technically impossible.

In some embodiments, the selection of the respective input page for assignment to the respective output page may involve picking a particular input page and searching among the destination subpages to which no input page has been assigned yet a suitable one, and vice versa in other embodiments or vice versa, picking a particular available destination data page and searching among the yet unassigned input pages a suitable one, so that the memory reliability optimization goal is satisfied.

In some embodiments, for each output page, selecting the respective corresponding input page comprises determining, for each input page, a respective associated indicator that characterizes the input page. Furthermore, selecting the input page for assignment to the output page comprises: (i) comparing the associated respective indicators of multiple input pages with the memory reliability optimization goal related to the level of the one or more destination data pages being associated with the output page, and (ii) determining one input page among the multiple input pages, which itself or the reversibly transformed version thereof satisfies the memory reliability optimization goal, as the selected input page. In this way, the matching of input pages and suitable output pages can be performed based on a single indicator and thus with high efficiency. The indicator is preferably a number and the memory reliability optimization goal is defined as a mathematical condition so that the comparison can be easily performed as a mathematical calculation. This can further increase the achievable efficiency.

The associated indicator of an input page may particularly be a function of the number of bits within the input page with the same predetermined bit value, e.g., “1”. The function may particularly be the identity function, i.e., the indicator may particularly be equal to the number of bits having said same predetermined bit value. Thus, since counting the occurrences of a particular bit value within a given bit pattern is an operation which typically involves low efforts, the achievable efficiency of determining the indicator(s) can be further increased.

In some embodiments, the input data is randomized, and before the restructuring, the input pages are defined based on the randomized input data. Randomizing the data is particularly helpful to mitigate of cell-to-cell (C2C) interferences and hence helps to improve the reliability of the flash memory.

In some embodiments, the respective memory reliability optimization goal associated with a given destination data page is selected as a function of the level of the destination data page as one of the following: (i) maximizing the number of “0” bit values to be stored to the destination data page; (ii) maximizing the number of “1” bit values to be stored to the destination data page; (iii) optimizing a balance between “0” bit values and “1” bit values to be stored to the destination data page, i.e., achieving or at least approximating, as much as possible, an equal number of occurrence of both bit values.

In some embodiments, the flash memory is a 3D NAND flash memory in which the physical pages are distributed over a plurality of stacked layers of the flash memory. In this case, the memory reliability optimization goal applying to a destination data page may be defined as a function of both the level of the destination data page and the layer to which the physical page having the destination data page pertains. In order to further optimize the restructuring of the input data, this definition takes into account that typically the physical properties of the memory cells of a 3D NAND flash memory vary from layer to layer. Specifically, in many 3D NAND flash technologies, memory cells located closer to one end of the stack have slightly different dimensions, e.g., in terms of the thickness of their tunnel oxide, than memory cells located closer to the opposing end of the stack. Accordingly, the stress resistance of the memory cells, e.g., of their tunnel oxides, may vary accordingly. The same can and will usually apply to their associated Error Bit Counts (EBC) which typically positively correlate with the stress resistance of the memory cells.

Accordingly, similarly as described above more generally, in the specific case of a 3D NAND flash memory, the respective memory reliability optimization goal associated with a given destination data page is selected as a function of both the level of the destination data page and the layer to which the physical page having the destination data page pertains as one of the following: (i) maximizing the number of “0” bit values to be stored to the destination data page; (ii) maximizing the number of “1” bit values to be stored to the destination data page; (iii) optimizing a balance between “0” bit values and “1” bit values to be stored to the destination data page, i.e., achieving or at least approximating, as much as possible, an equal number of occurrence of both bit values.

In both above-mentioned cases, i.e., in said more general case (which is particularly also applicable to 2D NAND flash memory, and in the 3D NAND flash memory case, one or more of the following definitions can be applied: (i) maximizing the number of “0” bit values is defined as satisfying the condition that the number of bits in an input page or a reversibly transformed version thereof which have a bit value of one is less than a defined upper threshold; (ii) maximizing the number of “1” bit values is defined as satisfying the condition that the number of bits in an input page or a reversibly transformed version thereof which have a bit value of one is greater than a defined lower threshold; and/or (iii) optimizing a balance between “0” bit values and “1” bit values is defined as satisfying the condition that the number of bits in an input page or a reversibly transformed version thereof which have a bit value of one is greater than a defined lower threshold and less than a defined upper threshold. These definitions have the advantage that they do not require an absolute maximum of the number of “0” bit values or the number of “0” bit values or an exact balancing thereof, but rather more relaxed requirements which may be satisfied easier and with less effort (e.g., with less iterations for finding a good match between input pages and output pages) and thus more efficiently.

In some embodiments, when multiple input pages or their reversibly transformed versions, respectively, satisfy the memory reliability optimization goal associated with the one or more destination data pages being associated with a given output page, an input page among these multiple input pages is selected for assignment to the output page for which a degree that quantifies the satisfaction of the memory reliability optimization goal, such as a respective size of an overachievement, if any, is maximized among the multiple input pages. Thus, a selection of a suitable input page can be performed, which selection is both simple (and thus efficient) and, at the same time, highly effective (in view of the desired high memory reliability).

In some embodiments, selecting the respective input page for assignment to the respective output page further comprises (i) selecting one input page among the yet-unassigned input pages and transforming it according to a reversible transformation scheme being determined as a function of this input page, to obtain said reversibly transformed version of this input page; and (ii) saving transformation information based on which the transformation can be reversed in a retrievable manner for a future recovery of the untransformed input page from its transformed version. The transformation scheme is defined based on the yet-untransformed input page and the memory reliability optimization goal associated with the output page's associated one or more destination data pages so as to reversibly replace, in the input page, one or more data representations being associated with respective first threshold voltages of the memory flash by a respective number of data representations being associated with respective second threshold voltages of the memory flash being lower than the corresponding first threshold voltages to obtain the transformed version of the input page.

Accordingly, these embodiments specify a way how the restructuring of the input data can be extended beyond rearranging it in accordance with the above-described way of defining the assignment of output pages to suitable input pages to also comprise an optimization of the content of one or more of the input pages by way of the transformation(s) so as to avoid using high Vth states, as much as possible. The saving of the transformation information, which is required to reverse the related transformation(s), helps to maintain the entropy of the stored data when reading it back and allows the flash memory to function as intended, i.e., to recover the input data from the data stored in the flash memory.

Particularly, the transformation may be performed, when (i.e., if or even only if) in the course of the restructuring, a determination is made that for a given output page no yet-unassigned input page can be found that satisfies the memory reliability optimization goal associated with the output page's associated one or more destination data pages. Accordingly, in some of these embodiments, the transformation is only used, when a restructuring involving a mere rearrangement of the input data is found insufficient to satisfy the memory reliability optimization goal while otherwise a mere rearrangement is performed. Thus, the use of the transformation, which typically involves more effort than a mere rearrangement, can be effectively limited to such situations, where it is needed to satisfy the memory reliability optimization goal. In this way, the method can be made more effective than without the possible while maintaining a high level of efficiency.

In some embodiments, the one input page is selected so among the yet-unassigned input pages that pre-transformation, it minimizes among these input pages a degree that quantifies a size of a remaining gap of the respective input page towards a satisfaction of the memory reliability optimization goal associated with the output page's associated one or more destination data pages. Accordingly, this particular selection of the one input page requires only a minimal modification of its content (i.e., minimal when compared to the required modifications for the other considered input pages) to satisfy the memory reliability optimization goal. This is particularly advantageous in view of the objective of safely avoiding any over-optimization that might adversely impact the reliability of the memory.

In some embodiments, transforming the one input page comprises inverting, in this input page, at least a subset of the data representations associated with respective first threshold voltages. This approach is highly efficient because inverting (i.e., bit flipping) is a simple and very efficient bit operation. Furthermore, the entropy of the input data can be effectively protected.

Said inverting of at least a subset of the data representations being associated with respective first threshold voltages may comprise applying a masking operation to each of the to-be-inverted data representations individually or collectively. The masking operation may comprise mathematically combining the input page with at least one mask having a defined bit pattern so that the masking operation results in an inversion of said to-be-inverted data representation. The combining may particularly use a Boolean XOR operation and one or more masks having solely bit values of “1”. Using a plurality of different masks, a corresponding plurality of different transformation results can be maintained from the pre-transformation input page and a suitable result in this plurality of results may then be selected as the transformed version of the input page. The other results can be discarded.

Specifically, for the masking operations, the input page may be segmented into multiple frames of a same frame size in terms of bits, wherein the sizes of the masks in terms of bits are equal to or a multiple of the frame size, while different masks may have same or different sizes. Using this frame-based approach enables a particularly simple implementation of the masking operations and particularly supports the objective of effectively minimizing the needed modifications of the input page to achieve the satisfaction of the applicable memory reliability optimization goal.

As already indicated above, the masking operation may be performed multiple times per input page with different masks. Among the multiple results obtained thereby, one result may be selected as the transformed version of the input page which result, i.e., transformed page, maximizes among the multiple results an achievement degree that quantifies a respective size of an overachievement of the memory reliability optimization goal associated with the output page's associated one or more destination data pages by the various results.

When multiple results share the maximum achievement degree, that result among these results may be selected as the transformed version of the input page, which deviates the least from its related untransformed input page in terms of the number of bits inverted under the related transformation.

Specifically, the selection of the one result may be performed using a Greedy algorithm. For example, the series of masking operations with the different masks may be defined so, that the size of the masks increases over time. Using a Greedy algorithm, the series may be terminated as soon as the Greedy algorithm finds a result which although satisfying the memory reliability optimization goal has a lower achievement degree than the previous result. The result among all results achieved so far which has the best achievement degree may then be chosen as the one result to be selected as the transformed version of the input page.

In some embodiments, the input data is provided or stored in a cache memory other than the multi-level flash memory, e.g., in an SLC flash memory or an SRAM memory, and the restructuring of the input data is performed in relation to the input data stored in the cache memory to obtain the output data. In this way, the advantages of caching, such as buffering an incoming data stream providing the input data, and the restructuring according to the method may be effectively combined and the multi-level flash memory itself does have to be used for the restructuring process. This helps further to avoid unnecessary damages to the multi-level flash memory and thus conserve its lifetime.

In some embodiments, the respective memory reliability optimization goals associated with the one or more destination data pages are each defined as a function of a calibration parameter which defines a common reliability margin of the memory reliability optimization goals. The memory reliability optimization goals may be defined in addition as a function of the destination data pages to which they pertain, e.g., as a function of the layer in a 3D NAND flash in which the data pages are located. While the calibration parameter serves to provide the possibility to fine-tune or otherwise calibrate the memory reliability optimization goals to define an applicable reliability margin, the dependence of the memory reliability optimization goals from the destination data pages may be used to take the physical differences of the physical pages to which the destination data pages pertain, into account to achieve an optimal definition of the memory reliability optimization goals for optimizing the reliability of the flash memory.

A second aspect of the present solution is directed to a data processing apparatus, such as a flash memory controller device, configured to carry out the method of the first aspect.

In some embodiments, the data processing apparatus comprises one or more processors and having access to a program memory in which one or more programs are, which when executed on the one or more processors cause the data processing apparatus to carry out the method of the first aspect.

Finally, a third aspect of the present solution is directed to a computer program or a computer program product, comprising instructions to cause the data processing apparatus to carry out the method according to the first aspect of the solution. Specifically, the instructions may be defined so that when they are executed on one or more processors of the data processing apparatus, they cause the data processing apparatus to carry out the method according to the first aspect of the solution.

The data processing apparatus of the second aspect may accordingly have a program memory in which the computer program is stored. Alternatively, the data processing apparatus may also be set up to access a computer program available externally, for example on one or more servers or other data processing units, via a communication link, in particular to exchange with it data used in the course of the execution of the computer program or representing outputs of the computer program.

The features and advantages explained with respect to the first aspect of the solution apply accordingly to the further aspects of the solution.

FIG. 1 schematically illustrates various flash technologies with different numbers of levels, namely single-level-cell flash (SLC), dual-level-cell flash (often referred to “MLC”, although herein, this term is used more broadly, as discussed above, to cover all types of multi-level cell flash technologies, i.e., those with two or more bits per cell (C)); and triple-level-cell flash (TLC). Beyond, TLC flash, even flash technologies having more than three levels (i.e., bits/cell) are possible, such as quad-level cell (QLC) or penta-level cell (PLC) having four or five levels, respectively.

Depending on the number k of different bit patterns that can be stored and distinguished per cell C, k-1 threshold voltages V_{TH} are defined, which are needed to enable a distinction of different charge levels of the flash memory cells which in turn correspond to a stored bit value (for SLC) or to a stored bit pattern (for multi-level flash), respectively, particularly for read-out of stored data. In the example of FIG. 1, seven threshold voltages V_{TH0}, . . . , V_{TH6} for the TLC flash memory are drawn.

Typically, a lower number of levels of the flash memory is more advantageous in terms of high reliability and high performance, while a higher number of levels is more advantageous in terms of high density and low manufacturing costs.

FIG. 2 schematically illustrates an exemplary 3D NAND flash memory block B. A 3D NAND flash memory is a type of non-volatile storage that stores data in a three-dimensional (3D) structure. The structure of a 3D NAND flash comprises multiple layers of interconnected transistors and capacitors, which are stacked on top of each other to increase the storage density. A bottom layer of the 3D NAND flash is the substrate, which is typically made of silicon. This layer provides the base for the entire structure and serves as an electrical pathway for the signals.

A thin layer of oxide, which is called tunneling oxide, is deposited on top of the substrate to act as a tunnel barrier. This layer helps to control the flow of electrons through the flash memory cells. The next one or more layers up is where the flash memory cells are located. These cells are made up of a series of transistors and capacitors that are interconnected to store data. Each cell can hold multiple bits of data (MLC), and they are arranged in a grid-like pattern within each cell-bearing layer.

Above the flash memory cells is an inspection gate, which acts as a barrier to prevent electrons from escaping during the read process. This gate also helps to improve the read speed and accuracy of the flash memory. A selective gate is another layer that separates the flash memory cells from the control circuitry. It allows a control circuitry to selectively turn on or off the cells to access the stored data. The control circuitry is located at the top of the 3D NAND flash structure. This includes the gate drivers, sense amplifiers, and other components that are necessary for reading and writing data to the flash memory cells.

Connecting the various layers within the 3D NAND flash is a complex network of interconnects. These interconnects allow the control circuitry to communicate with the flash memory cells and read or write data as needed. Multiple insulating layers are used throughout the structure to isolate the different layers and prevent electrical shorts between them. Electrodes are located at the top and bottom of the 3D NAND flash structure, providing a pathway for the electrons to flow through the memory cells.

The exemplary block B (FIG. 2) of the 3D NAND flash structure comprises (as part of the overall flash structure described above) a plurality of flash memory cells which are arranged in a layered manner, wherein each of multiple layers (planes) L₀, . . . , L_{M} comprises a subset of the memory cells C and the layers are stacked L₀, . . . , L_{M}. The number M of layers in current technologies has already reached more than M=100 layers and the industry constantly tries to push for even higher values of M to increase memory density and reduce costs even further. The 3D NAND flash memory block B comprises multiple columns in which the various memory cells C are located at the crossing points of the columns and the layers in the block B. Each row of cells C in a given layer and along one dimension within the layers defines a physical page P of block B, such as the exemplarily drawn pages P₀ and P_{N}. Accordingly, a number #P of pages is laterally and sequentially arranged along the other dimension within each layer.

By stacking these layers on top of each other, the storage density within the 3D NAND flash can be increased significantly compared to traditional 2D flash memories. This allows for more data to be stored in a smaller physical area, making it an attractive option for use in high-density storage devices such as smartphones and laptops.

FIG. 3 shows models of in its sub-figure (a) states of TLC flash cells and their 3-bit binary data representations (encoding), in its sub-figures (b) and (c) examples of threshold voltage distributions of two different flash technologies, and in its sub-figure (d) a chart to illustrate an exemplary typical dependency of the required voltage and time to program flash cells on different states.

### NAND Flash Memory

As already discussed above, NAND flash is organized into blocks and pages. MLC-pages are grouped into a plurality of data pages (one per level) that share the same physical cells. 3D NAND flash memory has its physical pages stacked on multiple layers. The physical pages are organized from bottom to top layer, see FIG. 3. When writing to TLC, for instance, three bits are stored per cell, and hence, data is mapped to three logical pages, which we call “data pages” herein: Least Significant Bit (LSB) and Page (LSP), Central Significant Bit (CSB), and Page (CSP), and Most Significant Bit (MSB) and Page (MSP), see FIG. 3. The basic NAND flash operations are read, write (program), and erase. These operations are supported at different granularity. For instance, reading and writing are at the level of a physical page, while erasing can only be done on a block level. However, the nature of the NAND flash cell does not support in-place updates. Hence, to rewrite/update a physical page, the block containing the physical page must first be erased.

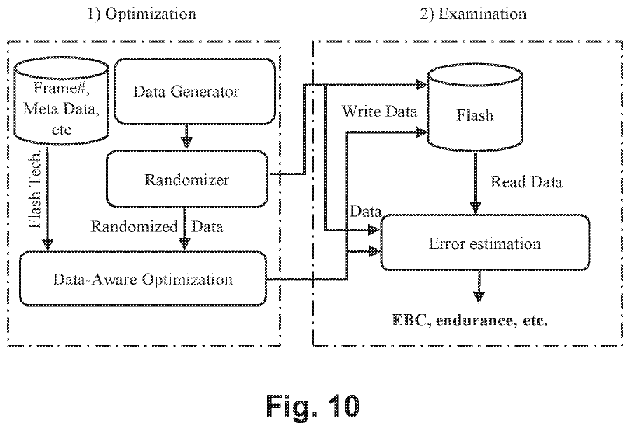

Write-Erase Cycle: On the one hand, writing to a flash memory cell works by storing the representative amounts of charge of the corresponding data bit(s), as shown in FIG. 2. This is achieved by applying the correct programming voltage and timing to allow the required amount of charge to be correctly transferred to the cell. The stored charge determines the respective threshold voltage V_{TH} of the flash cell, which is the minimum voltage required to turn the cell/transistor on when reading data. On the other hand, the erase operation of NAND flash, however, ejects the stored charge from the cells. Erase requires applying a high voltage on the gate of the cell. Notably, the high programming/erasing voltage stresses the flash cell and may cause unwanted impacts. Specifically, stress typically becomes more significant in MLC flashes than in SLC flashes. With every write-erase (W/E) cycle, permanent internal damage occurs within the flash cell due to hot-carrier injection and tunnel oxide degradation, such as trap generation. This, in turn, causes a gradual (i.e., incremental) degradation, defining the lifetime endurance of the flash. NAND flash endurance determines the maximum number of W/E cycles flash cells encounter while sustaining the ability to store charges correctly. For instance, the 3D TLC NAND flash that was used to generate the results discussed further below with reference to FIGS. 10 to 15 tolerates up to 3000 W/E cycles as the nominal endurance rate.

Caching: Storage devices (e.g., Solid State Drive (SSD)) store data typically upon arrival. However, writing to the flash is an atomic operation, where all the data should be copied to the flash memory device before programming the corresponding pages. For instance, in 3D TLC NAND flash, the three data pages (i.e., LSP, CSP, and MSP) must be available and transferred to the flash device before programming. However, a caching mechanism is compulsory if insufficient data is available or direct writing is not granted. It even helps to improve the writing throughput in MLC flashes, as writing to cache is way faster than writing to MLC flash. Thereafter, data migration is vital, copying the cached data into flash pages. Note that, this process is totally hidden from the host and usually does not impact the writing throughput. Moreover, the host (e.g., a computer using the flash memory for data storage) does not know the physical location of the data, which is fully managed by the memory device itself.

Interference: In NAND flashes, adjacent cells influence each other, which alters the stored logical values. As previously mentioned, the stored amount of charge represents the logical value (data) stored in a flash cell. Due to the coupling capacitance between flash cells, the V_{TH} of a flash cell can be changed while its neighboring cells are being programmed as charge leaks from one cell to another. Cell-to-cell (C2C) interference is a phenomenon where the threshold voltage of a flash cell being programmed unintentionally changes neighboring victim cell(s). Hence, the logical value of the victim cell becomes incorrect, resulting in corrupted data when reading data back.

Even after programming cells correctly, stored charge can still leak from one cell to another over time, changing the stored logical value of the victim cells, which impacts the data retention of the flash. Data retention defines the time that cells can maintain enough charge in order to read data correctly. Notably, the neighbor-cell state can affect the victim cell. The high similarity of charges (states) within the neighborhood is very destructive, provoking higher interference. On the other hand, the higher the neighbor-cell charge, the lower the threshold voltage shift. Therefore, the randomness of data compromises the impacts mentioned above, mitigating programming interference and improving data retention. Accordingly, using a randomizer within the memory device generally helps to avoid the worst-case neighboring charges.

Correction: NAND flash loses charge over time, making it inherently error-prone to errors. Therefore, stored binary data can be incorrectly interpreted due to bit flips. Hence, the stored data becomes corrupted when read. Flash memory devices employ sophisticated mechanisms to detect and correct errors, such as Error Correction Codes (ECC). ECC is commonly used in NAND flash devices to detect and correct bit errors. However, ECC has a limited capability of the number of corrections per data unit.

### Data Dependency

The impact of data on NAND flash's reliability can be very significant. As previously mentioned, with every W/E cycle, the internal flash cell degradation is gradually increased. The degradation level is directly proportional to the stress level and stress time (i.e., voltage level and time) applied to the cell. Hence, stress is determined by the applied voltage for writing (programming) and erasing as well as writing time. The present solution considers only degradation caused by writing, which can be—to some degree—mitigated if data is organized and tailored in a reliability-aware manner, as will be explained in more detail further below.

Each data representation has a unique amount of charge that should be stored within the cell. The larger the stored charge (i.e., V_{TH}), the higher the stress (i.e., higher voltage and longer time, see FIG. 3(d), which amplifies, in turn, the internal degradation of the flash cell and vice versa. Therefore, the flash degradation level is data-dependent. Moreover, the higher the V_{TH}, the lower the reliability due to its high electric field across the tunnel oxide.

FIG. 3(a) shows TLC flash cell states S which are defined as SER (i.e., erase) and states SA through SG, wherein each state has a unique data representation.

FIGS. 3(b) and (c) show the threshold voltage V_{TH} distributions and data representations of each Vth for two flash technologies. As shown, technologies have different representations of V_{TH} (i.e., different amounts of charge) and states.

FIG. 3(d) shows a programming voltage required for each V_{TH} (i.e., states) and the corresponding programming time. As shown, the higher the V_{TH}, the higher the required voltage and the longer the programming time, and vice versa. Hence, the right-side states in FIGS. 3(a)-3(c) are more degradation-cause to flash cells than the left. For instance, state SG results in more degradation than state SA. However, this should be aligned with technology since states could have different logical representations when considering actual data.

### Data-Aware Characterization

NAND flash vendors typically urge randomizing the stored data in every page. In turn, this helps to mitigate the C2C interference and, hence, improves reliability. Therefore, NAND flash's reliability is again data-dependent, which is also impacted based on the cell and neighborhood contents.

In the course of developing the present solution, various synthetic data patterns (around 20 data sets) for 3D TLC NAND flash were generated to characterize the reliability-data dependency. The data patterns were synthetically tailored to cover all possible use cases under the awareness and unawareness of the flash technology (e.g., 3D structure and W/E degradation (FIG. 3)).

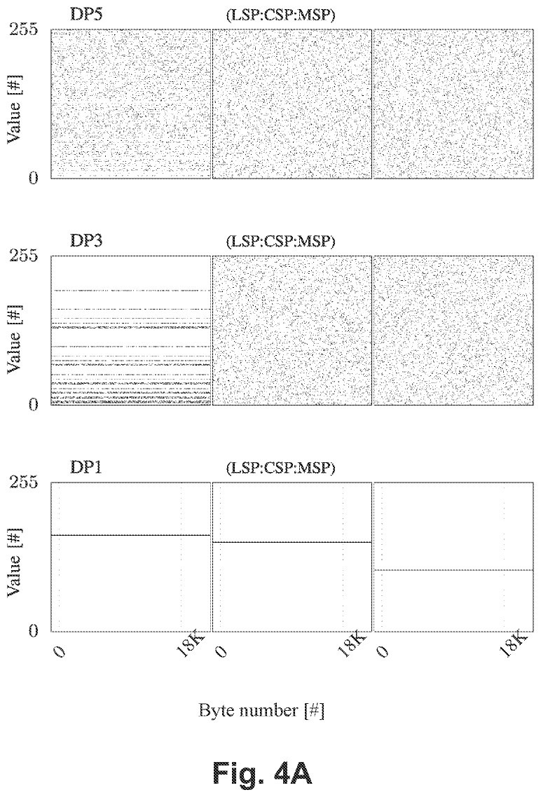

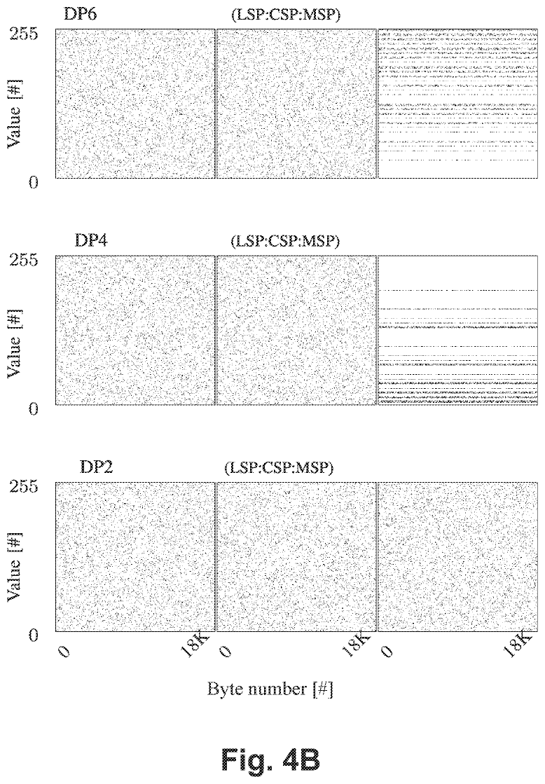

FIGS. 4A and 4B collectively show a subset of the above-mentioned data sets, the subset consisting of six different exemplary synthetic data pattern (DP) distributions for both TLC NAND flash technologies of FIGS. 3(b) and 3(c). Specifically, FIGS. 4A and 4B each show a different byte distribution of a data sequence within a physical page having three associated data pages corresponding to the three levels of the TLC flash memory.

(DP1): Data is tailored to cover the order of all unique values of TLC (i.e., three bits of eight states to form three bytes (3×8) for LSB, CSB, and MSB, based on FIG. 3(c) coding) repetitively in sequence, and then applied everywhere, shifting similar patterns of adjacent cells, considering the 3D structure of the flash, to avoid neighborhood similarity.

(DP2): Data is randomly generated for the whole block considering the 3D structure of the NAND flash (i.e., layer number is the seed for the random generator).

(DP3): Data is randomly generated for the whole block considering the 3D structure of the NAND flash. Data is biased only for LSP to contain more binary zero values.

(DP4): Data is randomly generated for the whole block considering the 3D structure of the NAND flash. Data is biased only for LSP to contain more binary one values.

(DP5): Data is randomly generated for the whole block considering the 3D structure of the NAND flash. Data is biased only for MSP to contain more binary zero values.

(DP6): Data is randomly generated for the whole block considering the 3D structure of the NAND flash. Data is biased only for MSP to contain more binary one values.

FIGS. 4A and 4B show the data sequence (i.e., byte-wise distribution) within the three data pages (i.e., LSP, CSP, and MSP) of the previously mentioned DPs. As can be noticed, data values are fully randomized in all DPs except for DP1.

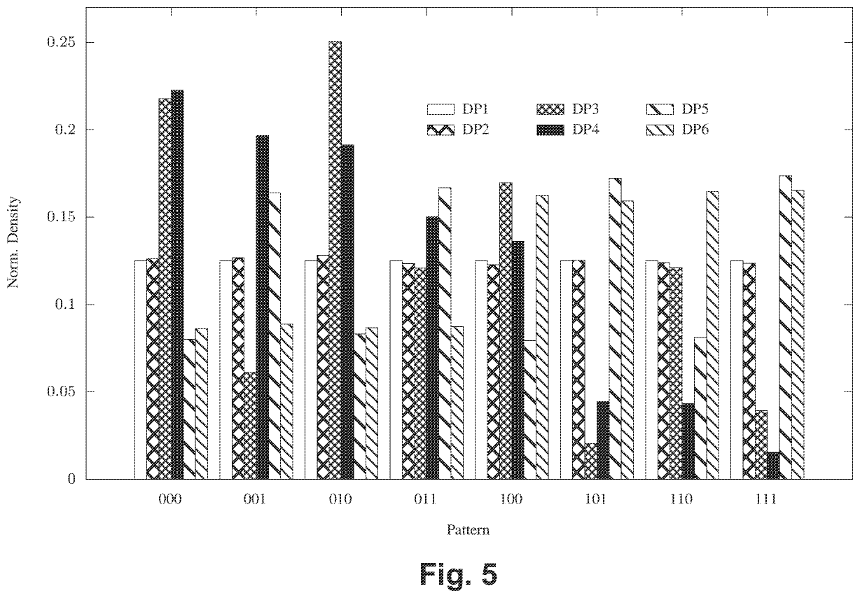

FIG. 5 shows a state (i.e., 3 bit-wise) histogram of the synthetic data patterns (DP) of FIGS. 4A and 4B for TLC flash, wherein the density is normalized to the size of the page in bytes, e.g., 18336 Bytes. As can be noticed, histogram-wise (not bit-wise), DP1 has almost similar contents to DP2 where logical states are almost balanced for both cases. Moreover, DPs with random data still have different histograms as intended. DP3-DP6 are generated by shifting states to the left for specific technology, as shown in FIG. 3, increasing the occurrence of ones or zeros in specific pages. This, in turn, increases the probability of occurrence of specific states by biasing data contents. As FIGS. 3(b) and (c) show, the biased data increases/decreases the density (i.e., occurrence) of states (i.e., V_{TH}). DP3 and DP6 are used for coding in FIG. 3(b) technology, while DP4 and DP5 are used for coding in FIG. 3(c) technology. Applying DPs with the other technology results in very high W/E over W/E cycles, increasing stress on cells since higher Vth is applied for programming. For instance, following FIG. 3(b), an increasing number of ones in MSP (i.e., DP6) or increasing zeros in LSP (DP3) will increase V_{TH} occurrences to the left side. Which, in turn, potentially suppresses the degradation caused by W/E cycles.

To quantify reliability degradation caused by each DP combined with W/E, the reliability of the test flash memories described above was examined. Each DP was used to stress a block for W/E=1000 cycles. Afterwards, the reliability of the block was examined ten minutes after programming. The reliability metric in this scope is the Error Bit Count (EBC), which refers to the number of bit flips in a page without using ECC for corrections. Note, in this section, results show solely EBC under W/E to isolate other reliability threats. Further below, reliability under W/E, data retention, and layer-to-layer variations will also be examined, as they have the most significant reliability threats in recent 3D flashes.

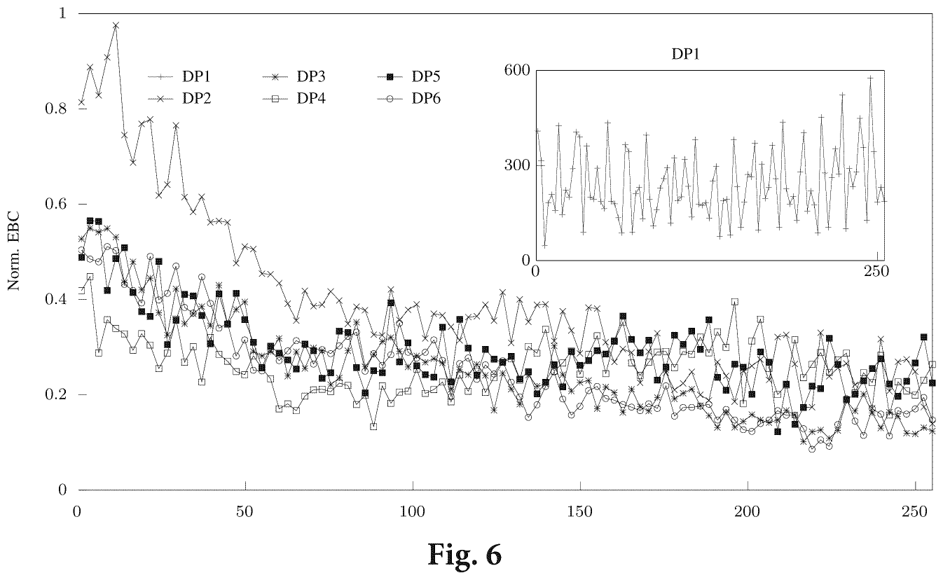

FIG. 6 shows the results of these tests for two different technologies. Specifically, FIG. 6 shows the normalized EBC of DPs to the maximum EBC of DP2 as a baseline. For visibility purposes, the EBC of a DP is selected as the maximum EBC of the three pages sharing the same physical cells (i.e., EBC=Max EBC (LSP, CSP, MSP)) Note that maximum EBC is selected since it defines the worst-case scenario, and hence, the required correction capability of any NAND flash controller. Variations between EBC of different page types are still noticeable and will be considered for later optimization.

Results show that different DPs show different EBC, which is directly related to the internal degradation with every W/E cycle and slight C2C interference as no data retention is used. For instance, even though the data seems to be bit-wisely unique within the DP1 sequence, DP1's EBC is very high (around 600× of DP2) because the neighborhood has an akin level of charges, violating the randomness constraints, which significantly aggravates the program disturbance as well as C2C interference. This highlights the importance of the randomizer as in DP2. DP2 uses a state-of-the-art randomizer based on vendors' recommendations. However, DP2 predominantly shows a higher maximum EBC compared to biased DPs. This is expected as DP3-DP6 are designed to suppress the degradation with a predominantly significant reduction in EBC.

Importantly, there is no single optimal DP for the whole range of pages and different technologies. DP3 and DP6, for instance, alternatively reduce EBC over pages on technology FIG. 3(b) while significantly increasing EBC on technology FIG. 3(c). Therefore, a compromise is required by combining more than one DP to maximize gains and sustain optimality considering the underneath technology. Moreover, as DP2 is the typical form of the stored data in flash memory devices, optimizing DP2 to be akin to synthetic patterns is apparently the only way toward data-aware flash reliability. Notably, EBC is reduced towards higher pages with all DPs, as top layers are typically more tolerable to degradation, as the fabrication process tends to make them bigger cells.

In summary, the results of the above-described characterization suggest that flash contents can be optimized in view of the above-defined objective of increasing flash reliability and endurance by maximizing the density of the left-side states (in FIG. 2) of data (lower V_{TH} states, e.g., SER-SE) while reducing right-side states. This means that each page type (i.e., data page type) should have a different optimization goal and consider the variations between cells as recommendable. The optimization must be aware of the data and should be done systematically without obliterating the entropy of the stored data. However, optimization must be conditionally reversible to maintain the entropy of data when reading it back and allow the memory device to function as intended.

The method of the present solution, which due to its dependency on the data to be stored may also be designated as “data-aware slash reliability optimization technique” will now be described in more detail based on exemplary embodiments.

The technique is based on optimizing data before writing it to flash memory. As the host (which may provide the data to be stored and/or request a read-out of already stored data) does not know the actual physical location of the stored data in the flash memory, the memory device is privileged to organize and modify data based on the management technique it employs. The proposed technique seeks to be generic (i.e., applicable to any NAND flash technology), which is a preferable further objective in view of the variety of flash technologies that have different representations of the stored charge, and the fact that the data representation may differ from one flash vendor to another. Therefore, based on the flash technology's characteristics, the technique may be used as a post-optimization of input data, such as a randomizer's output.

Notably, the technique may particularly be used in connection with input data that is already randomized and cached or will be treated so upon arrival (e.g., at the memory controller performing the technique). Specifically, the data may be collected into SRAM cache to complete three pages size (i.e., as in TLC) and then be randomized and written into the flash memory. In many cases, SLC cache pages are used instead of expensive SRAM. Therefore, in these cases, data is already randomized when reading back from the SLC cache. Note that the technique works with data migration, typically done when enough pages are cached. However, the technique may also be employed in cache-less memory devices that use direct writing to the flash before writing data into flash, which could slightly impact the writing throughput. The data-aware flash reliability optimization technique aims at suppressing the internal degradation caused by every W/E cycle, reducing EBC, and/or prolonging the memory device's lifetime.

### Data-Aware Reliability Modeling

As the characterization described above shows, each data page type should receive a unique data pattern to enable data-aware flash reliability. For instance, an LSP requires more content of logical zeros than ones. The technique helps to increase the probability of desired pattern occurrences while sustaining randomness of data. This supports may particularly support fast runtime decisions and may requires fewer resources.

A page's content, particularly an input page's contents may be quantified by a suitable associated indicator, such as the sum of occurrences of logical ones and/or zeros (i.e., bits of value “1” or “0”, respectively) in the (input) page. Equations (1) and (2) provided below are examples for this approach:

$${Page}_{Z e r o s} = ( {\sum }_{b = 0}^{m} bit ( ! b ) ) / m > Zeros \qquad ( 1 )$$

$${Page}_{O n e s} = ( {\sum }_{b = 0}^{m} bit ( b ) ) / m > Ones \qquad ( 2 )$$

wherein m is number of bits per page, Page_{zeros} and Pageₒₙₑₛ are indicators defined as the sum of occurrences of logical zeros and/or ones, respectively in the page, and “Ones” and “Zeros” are threshold constants (e.g., 60%). Accordingly, a page satisfying the condition expressed in eq. (1) has more occurrences of “0” bit values in the page than the threshold constant Zeros, and similarly, a page satisfying the condition expressed in eq. (2) has more occurrences of “1” bit values in the page than the threshold constant Ones.

Randomized data should not be modified in order to unrandomize the data when reading it back. Otherwise, changes would need to be tracked. Therefore, the technique considers minimal changes by only inverting portions of the input page (i.e., flipping logical bits 0→1 and 1→0), which can easily be tracked at a negligible overhead, as explained later. The technique may be summarized as an optimization algorithm that selects pages' locations based on their contents, flash technology, and page types, as well as (optionally) optimizes the page contents. The technique tries to restructure the input data so as to keep the threshold voltages V_{TH} of the flash cells at the left side of the V_{TH} distribution, i.e., at lower V_{TH} states, as much as possible, while sustaining the randomness of data.

The optimization goals for the exemplary embodiment of the technique can be modeled as defined in the following equations:

$$Page [ i ] ( l ) = \{ \begin{matrix}Max Zeros , & {\sum }_{b = 0}^{m} Bit ( b ) < {Z}_{t h} ( l ) \\ Max Ones , & {\sum }_{b = 0}^{m} Bit ( b ) > {O}_{t h} ( l ) \\ Balance , & \begin{matrix}{Z}_{t h} ( l ) < {\sum }_{b = 0}^{m} \\ Bit ( b ) < {O}_{t h} ( l )\end{matrix}\end{matrix} \qquad ( 3 )$$

wherein Page is the selected page, l is the page's layer number (e.g., l=1 for layer L₁) for 3D flash, index i represents a page type (e.g., LSP, or CSP), m is the number of bits in a page, Zₜₕ and Oₜₕ are optimization constraints as defined in Eq. (4) and Eq. (5) provided below. The page with page type index i is selected, e.g., greedily selected, if it satisfies the optimization goal (memory reliability optimization goal) based on the available meta-data.

The optimization itself may particularly be implemented as a multi-objective optimization process that tries to maximize the profit greedily with a minimal number of modifications, if any, to the input data. Thus, we sustain the randomness of data with minimal read performance overhead. Note that any generic multi-objective algorithm can be used for the technique under given optimization goals. The (memory reliability) optimization goals (for a logical page P[i]) can particularly be defined in accordance with Eq. (3) in an abbreviated form as follows:
MaxZeros: Maximizing number of zeros (Eq. (1))
MaxOnes: Maximizing number of ones (Eq. (2))
Balance: Balanced content, i.e., number of ones=number of zeros

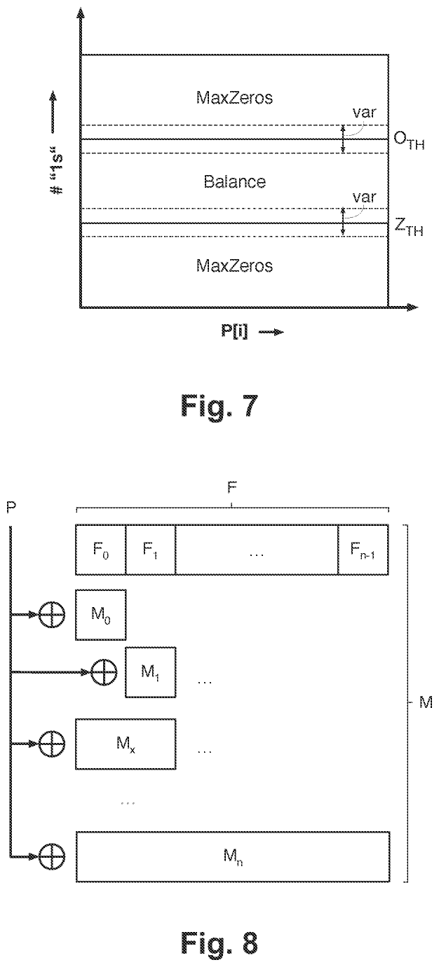

To consider layer process variations, where optimization levels might be differently required and to make the technique more generic, the model categorizes pages' contents into three levels/regions based on defined constraints, as shown in FIG. 7 and Eq. (3). The thresholds may particularly be defined based on an experimental examination and defined for each layer and can even be tuned at runtime. However, using a single level of optimization for all layers is still possible, although it will typically result in noticeable EBC differences between different layers.

The optimization constraints Zₜₕ and Oₜₕ may be defined as in Eq. (4) and Eq. (5) below for the number of zeros and ones, respectively, considering variations across the layers.

$${Z}_{t h} ( l ) = {ϵ}_{z} [ l ] - α \qquad ( 4 )$$

$${O}_{t h} ( l ) = {ϵ}_{o} [ l ] + α \qquad ( 5 )$$

$$MaskPage = Page [ i ] ⊕ {I}_{m} [ j ] \qquad ( 6 )$$

Where ϵ_{z} is an experimental “zeros” threshold array, ϵ₀ is an experimental “ones” threshold array, α is a calibration constant (which can be used to define a layer-independent variation var of the constraints in FIG. 7), MaskPage is the masked page, and Iₘ is an array of different inverting masks (i.e., vectors of logical ones for bit inversion). Iₘ is generated by splitting the page into a defined number n of frames F, e.g., into Frames F₀, F₁, . . . , Fₙ, and then finding all inversion combinations between these segments. Such an optimization aims at greedily selecting pages with contents that maximize the optimization goals (profit).

This is done by inverting portions of the page's contents (see Eq. (6)). Therefore, the exemplary optimization (i.e., data restructuring) algorithm (“algorithm 1”) discussed in more detail below splits the input page into various frames, evaluates all optimization scenarios (i.e., invert frames) as shown in FIG. 8 and then greedily selects the solution that maximizes the profit with minimal changes. The set M of masks may comprise masks of different sizes, e.g., mask (M₁, M₂) of the size of a single frame and masks (Mₓ) of a greater size, such as the size of multiple frames up to a mask (Mₙ) of the size of the whole page. In the present example, the masks are completely filled with only ones so that combining the input page's content with the mask using a Boolean exclusive-or (XOR) operation results in a flipping of the bits in the page which are covered by the mask. Obviously, an XOR operation is per se a reversible operation because combining the result a second time with the same mask yields the original page. Therefore, also the resulting transformation scheme of the input page which is defined by the mask relating to the above-mentioned greedily selected solution provides a reversible transformation. Accordingly, applying the selected transformation to the input page yields a transformed version thereof, which has an optimized content in view of decreasing degradation and increasing the lifetime of the flash memory.

### Data-Aware Reliability Optimization Algorithm

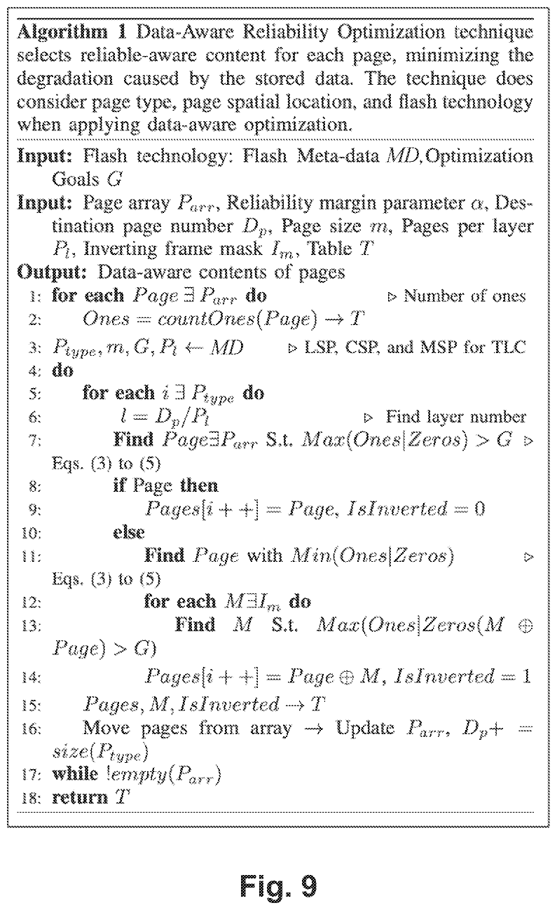

FIG. 9 shows, in pseudocode, an exemplary first embodiment of a method of restructuring input data to be stored in a multi-level NAND flash memory, according to the present solution;

The method of the exemplary technique is summarized in Algorithm 1 provided in FIG. 9. This algorithm first quantifies pages contents by counting the number of ones in all cached input pages (“Pages” stored in a page array Pₐᵣᵣ) storing results in a result table T, as shown in Line 1 and Line 2.

In order to consider the underneath flash technology, the algorithm then reads the meta-data MD of the flash technology (i.e., V_{TH} distributions, page size m, page types, data coding, etc.), and then it defines the optimization goals G (e.g., per (data) page type (Line 3), e.g., according to eq. (3).

Then, the algorithm applies a restructuring of the input pages by performing a data-aware flash reliability optimization process involving selecting the pages' contents to satisfy the optimization constraints (see Eq. (3)) to suppress the damage caused by the stored data (Line 5 to Line 17). The optimization works individually for each page type P_{type} (Line 5), and then finds the layer l of the current physical destination page D_{P} ((Line 6) to select the optimization goal G as a function of this layer l.

Then, the algorithm examines all available solutions (input pages) that satisfy optimization goals and greedily selects the optimal one that maximizes profit (Line 7 to Line 9). The algorithm also works to optimize available pages directly for the desired locations to match the write order constraint on flash pages in a block (i.e., between LSB/CSB/MSB pages and between layers) by only selecting the available three pages in the TLC case and optimizing them considering page type and layer. In case of insufficient data, a memory controller can generate random data, which must also be optimized.

Note that data pages should preferably be randomized to minimize the dependence of the error rate on data values. Good randomization aims to generate an equal number of randomly distributed zeros and ones to have a similar degree of degradation over W/E, leaving little room for optimization. Therefore, the algorithm optimizes the input page contents to change the number of zeros and ones if no solution is found.

The algorithm thus continues by looking for pages satisfying the required optimization goals G (Line 7). This is done by examining number of ones or zeros following the page type and layer number.

(Only) if no solution exists, then the algorithm selects the best candidate page for optimization as the one with the highest probability of satisfying the optimization constraints quickly and not being a solution candidate (Line 11). It is assumed that the best candidate page is the one which has a minimal number of ones or zeros, respectively, depending on the optimization goal G.

Then, the algorithm examines all predefined inverting masks M in Iₘ to greedly find the one mask M, application of which satisfies the goal G (Line 13).

The final masking can be formed of a combination of multiple frames F with corresponding masks M, each mask M being represented as an inverting binary vector indicating the corresponding frame's inversion. Note, the smaller the mask size, the better the solution and, hence, reliability, but at the cost of performance and increasing the overhead of the management data. Importantly, over-optimization might result in more inadequate reliability. Over-optimization is optimizing data beyond a limit where high neighborhood similarity is observed, which largely eliminates the randomizer's work. Therefore, the algorithm applies a conservative selection by applying minimal modifications (i.e., minimum masking) to satisfy the optimization goal G.

Afterwards, the algorithm updates the result table T with all needed management data (Line 15), e.g., page contents, inverting vector, etc. The algorithm optimizes all cached pages, assuming enough pages are available. Otherwise, the remaining data waits for the next iteration, or random data can be written. Importantly, the technique is generic and works on any available data for optimization. At the same time, the technique is a multi-objective optimization technique.

FIG. 10 shows an exemplary process flow for restructuring input data to be stored in a multi-level NAND flash memory according to the present solution an examination of the results of an optimization achieved by the restructuring.

A data generator, such as a host computer, generates and provides input data to be stored in the flash memory (Flash). In the course of the optimization process, the input data is first randomized and then further processed by the data-aware restructuring (optimization) method of the present solution, which receives flash technology data specifying details of the technology of the flash memory and other relevant information for the restructuring process (cf. FIG. 9) as further inputs from a data repository.

The data-aware restructuring (optimization) process yields for each input page in the input data a corresponding output page in the output data of the process as a result of the optimization. The output data is sent to the flash memory for storage therein (Write data).

FIG. 10 also shows an examination process for testing the effectiveness of the restructuring process. To that purpose, both the randomized input data and the output data resulting from the optimization are both stored in the flash memory and also provided to an error estimation process which is configured to estimate error rates (e.g., normed EBC) occurring in the stored randomized input data on the one hand and in the corresponding stored optimized output data after a given number of W/E cycles have been performed. These error rates can then be compared to estimate the effectiveness of the optimization process.

### Exemplary Evaluation Results

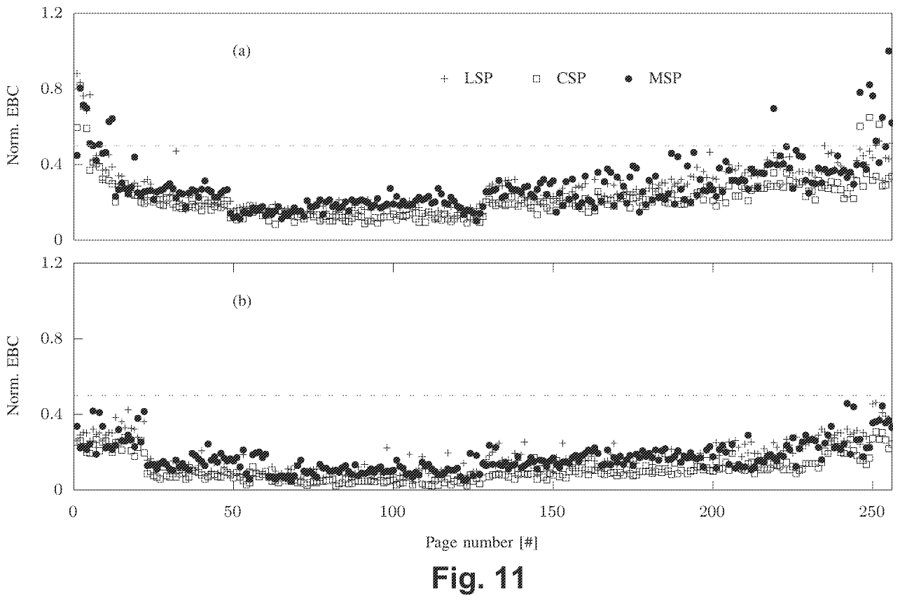

FIG. 11 shows exemplary results for the EBC of (a) data-unaware (DU) and (b) data-aware (DA) scenarios under the W/E cycles=1000 of the three-page types, EBC normalized to the maximum value of (a). The results were obtained using the method of FIG. 10 in combination with the method of FIG. 9 for the data-aware (DA) optimization.

A set of blocks using both DU and DA scenarios was tested. The first and last 12 layers' pages for DA were optimized (restructured) by increasing the optimization constraints while using lighter constraints for internal layers. Furthermore, the data retention time was extended to highlight further the EBC results of the top layers. FIG. 11 shows the EBC of the two scenarios (i.e., DU and DA) normalized to the maximum EBC in DU.

FIG. 11(a) shows the typical scenario, and as can be noticed, EBC at the bottom and top layers are very significant compared to internal layers. Top and bottom layers EBC are higher than 50% over all other layers. This can be explained with multiple aspects:
(1) the bottom layers are of smaller size than other layers due to the fabrication process, which aggravates the impact of the internal damage.
(2) the top layers are the victim of a higher erase voltage than other layers, which increases in turn the internal cell's damage over W/E.
(3) bigger cells at top layers are more subject to C2C as cells become closer to each other compared to bottom layers.

Because of such significant EBC, endurance, and retention of the NAND memory device can be very limited to the top and bottom layers. At the same time, many pages are still in good condition.

However, FIG. 11(b) shows how DU can suppress such variation under the same operating conditions, hence improving the reliability and prolonged lifetime of the device. Therefore, DA can greatly benefit when applied spatially to optimize the desired layers only to mitigate any process variation (e.g., L2L).

Memory System with Data Processing Apparatus

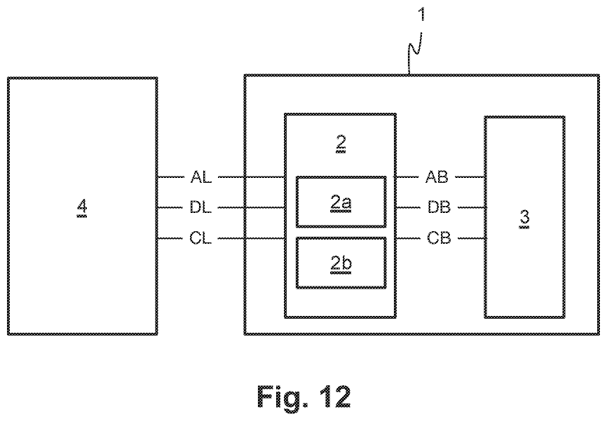

FIG. 12 shows an exemplary memory system 1 comprising a memory controller 2 and a NAND flash memory device 3, e.g., of the 3D NAND TLC type. The memory system 1 is connected to a host 4, such as a computer to which the memory system 1 pertains, via a set of address lines A1, a set of data lines D1 and set of control lines C1. The memory controller 2 comprises a processing unit 2a and an internal memory 2b, typically of the embedded type, and is connected to the flash memory 3 via an address bus A2, a data bus D2, and a control bus C2. Accordingly, host 4 has indirect read and/or write access to the memory 3 via its connections A1, D1 and C1 to the memory controller 2, which in turn can directly access the memory 3 via the buses A2, D2 and C2. Each of the set of lines respectively buses A1, B1, C1, A2, B2 and C2 may be implemented by one or more individual communication lines.

The memory controller 2 is configured as a data processing device being adapted to perform the method of the present solution, particularly as described below with reference to FIGS. 7 to 9. To that purpose, the memory controller 2 may comprise a computer program residing in its internal memory 2b which is configured to perform the method when executed on the processing unit 2a of the memory controller 2. Alternatively, the program may for example reside, in whole or in part, in memory 3 or in an additional program memory (not shown) or may even be implemented by a hard-wired circuit.

While above at least one exemplary embodiment of the present solution has been described, it has to be noted that a great number of variations thereto exists. Furthermore, it is appreciated that the described exemplary embodiments only illustrate non-limiting examples of how the present solution can be implemented and that it is not intended to limit the scope, the application or the configuration of the herein-described apparatuses and methods. Rather, the preceding description will provide the person skilled in the art with constructions for implementing at least one exemplary embodiment of the present solution, wherein it must be understood that various changes of functionality and the arrangement of the elements of the exemplary embodiment can be made, without deviating from the subject-matter defined by the appended claims and their legal equivalents.

### LIST OF REFERENCE SIGNS

1 memory system
2 memory controller, including coding device
2a processing unit
2b embedded memory of memory controller
3 nonvolatile memory, particularly flash memory
4 host
A1 address line(s)
D1 data line(s)
C1 control line(s)
A2 address bus
D2 data bus
C2 control bus
B flash memory block
C flash memory cell
CD cell degradation
D probability density
DPₓ data patterns
Dₚ number of (physical) destination page
EBC error bit count
F, Fₓ frames
G (memory reliability) optimization goal
i index for page type
Iₘ set of frame masks M
Lₓ layers
m page size, in number of bits
M, Mₓ (frame) masks
MD flash meta-data
Ones number of bit values “1”
O_{TH} (upper) optimization constraint
Z_{TH} (lower) optimization constraint
P page, esp. input page
Pₐᵣᵣ page array, storing and defining page structure of input pages
Pₗ number of pages per layer
P_{type} type of data page, e.g., MSP, CSP, or LSP in the case of TLC flash
Pages [ ] array of output pages
Page input page
α reliability margin parameter
P₀ physical page number 0
P_{N} physical page number N #P page numbering
S, Sₓ states of a memory cell, e.g., TLC cell
T result table
T_{P} programming time
V_{P} programming voltage
V_{THx} threshold voltages
V Voltage
Zeros number of bit values “0”
⊕ Boolean XOR operation

1. A method of restructuring input data to be stored in a flash memory having a plurality of multi-level flash memory cells being arranged in multiple physical pages each having a defined number N>1 of data pages corresponding to the different levels of the multi-level flash memory, the method comprising:
based on a defined page structure according to which the input data is segmented into multiple logical input pages, restructuring the segmented input data to obtain corresponding output data being segmented into logical output pages, wherein each output page has one or more associated destination data pages for storing content of the output page therein; and
outputting the segmented output data for storage to the flash memory in accordance with the associations between the output pages and their respective destination data pages;
wherein the restructuring comprises:
assigning to each output page a respective corresponding input page, and wherein selecting the respective input page for assignment to the respective output page is based on:
the level of the one or more destination data pages being associated with the output page,
the content of the input page, and
a memory reliability optimization goal defined as a function of the level of the one or more destination data pages being associated with the output page,
wherein the input page is selected so that the input page or a reversibly transformed version thereof satisfies the memory reliability optimization goal associated with the output page's associated one or more destination data pages, and the content of the output page is defined accordingly as that of the input page or its reversibly transformed version, respectively.

2. The method of claim 1, wherein for each output page, selecting the respective corresponding input page comprises determining for each of the input pages a respective associated indicator that characterizes the input page; and
selecting the input page for assignment to the output page comprises:
comparing of the associated respective indicators of multiple input pages with the memory reliability optimization goal related to the level of the one or more destination data pages being associated with the output page, and
determining one input page among the multiple input pages, which itself or the reversibly transformed version thereof satisfies the memory reliability optimization goal, as the selected input page.

3. The method of claim 2, wherein the associated indicator of an input page is a function of the number of bits within the input page with the same predetermined bit value.

4. The method of claim 1, wherein:
the input data is randomized, and
before the restructuring, the input pages are defined based on the randomized input data.

5. The method of claim 1, wherein the respective memory reliability optimization goal associated with a given destination data page is selected as a function of the level of the destination data page as one of the following:
maximizing the number of “0” bit values to be stored to the destination data page;
maximizing the number of “1” bit values to be stored to the destination data page;
optimizing a balance between “0” bit values and “1” bit values to be stored to the destination data page.

6. The method of claim 1, wherein:
the flash memory is a 3D NAND flash memory in which the physical pages are distributed over a plurality of stacked layers of the flash memory; and
the memory reliability optimization goal applied to a destination data page is defined as a function of both the level of the destination data page and the layer to which the physical page having the destination data page pertains.

7. The method of claim 6, wherein the respective memory reliability optimization goal associated with a given destination data page is selected as a function of both the level of the destination data page and the layer to which the physical page having the destination data page pertains as one of the following:
maximizing the number of “0” bit values to be stored to the destination data page;
maximizing the number of “1” bit values to be stored to the destination data page;
optimizing a balance between “0” bit values and “1” bit values to be stored to destination data page.

8. The method of claim 5, wherein:
maximizing the number of “0” bit values is defined as satisfying the condition that the number of bits in an input page or a reversibly transformed version thereof which have a bit value of one is less than a defined upper threshold;
maximizing the number of “1” bit values is defined as satisfying the condition that the number of bits in an input page or a reversibly transformed version thereof which have a bit value of one is greater than a defined lower threshold; or
optimizing a balance between “0” bit values and “1” bit values is defined as satisfying the condition that the number of bits in an input page or a reversibly transformed version thereof which have a bit value of one is greater than a defined lower threshold and less than a defined upper threshold.

9. The method of claim 1, wherein when multiple input pages or their reversibly transformed versions, respectively, satisfy the memory reliability optimization goal associated with the one or more destination data pages being associated with a given output page, an input page among these multiple input pages is selected for assignment to the output page for which a degree that quantifies the satisfaction of the memory reliability optimization goal is maximized among the multiple input pages.

10. The method of claim 1, wherein selecting the respective input page for assignment to the respective output page further comprises selecting one input page among the yet-unassigned input pages and transforming it according to a reversible transformation scheme being determined as a function of this input page, to obtain said reversibly transformed version of this input page; and
saving transformation information based on which the transformation can be reversed in a retrievable manner for a future recovery of the untransformed input page from its transformed version;
wherein the transformation scheme is defined based on the yet-untransformed input page and the memory reliability optimization goal associated with the output page's associated one or more destination data pages to reversibly replace, in the input page, one or more data representations being associated with respective first threshold voltages of the memory flash by a respective number of data representations being associated with respective second threshold voltages of the memory flash being lower than the corresponding first threshold voltages to obtain the transformed version of the input page.

11. The method of claim 10, wherein the transformation is performed, when in the course of the restructuring, a determination is made that for a given output page no yet-unassigned input page can be found that satisfies the memory reliability optimization goal associated with the output page's associated one or more destination data pages.

12. The method of claim 10 wherein the one input page is selected so among the yet-unassigned input pages that pre-transformation, it minimizes among these input pages a degree that quantifies a size of a remaining gap of the respective input page towards a satisfaction of the memory reliability optimization goal associated with the output page's associated one or more destination data pages.

13. The method of claim 10, wherein transforming the one input page comprises inverting, in this input page, at least a subset of the data representations being associated with respective first threshold voltages.

14. The method of claim 13, wherein said inverting of at least a subset of the data representations being associated with respective first threshold voltages comprises applying a masking operation to each of the to-be-inverted data representations individually or collectively, the masking operation comprising mathematically combining the input page with at least one mask having a defined bit pattern so that the masking operation results in an inversion of said to-be-inverted data representation.

15. The method of claim 14, wherein for the masking operations, the input page is segmented into multiple frames of a same frame size in terms of bits, wherein the sizes of the masks in terms of bits are equal to or a multiple of the frame size.

16. The method of claim 14, wherein:
the masking operation is performed multiple times per input page with different masks;
and among the multiple results obtained thereby, one result is selected as the transformed version of the input page which result maximizes among the multiple results an achievement degree that quantifies a respective size of an overachievement of the memory reliability optimization goal associated with the output page's associated one or more destination data pages by the various results.

17. The method of claim 16, wherein when multiple results share the maximum achievement degree, that result among these results is selected as the transformed version of the input page, which deviates the least from its related untransformed input page in terms of the number of bits that were inverted under the related transformation.

18. The method of claim 16, wherein the selection of the one result is performed using a Greedy algorithm.

19. The method of claim 1, wherein the input data is provided or stored in a cache memory other than the multi-level flash memory and the restructuring of the input data is performed in relation to the input data stored in the cache memory to obtain the output data.

20. The method of claim 1, wherein the respective memory reliability optimization goals associated with the one or more destination data pages are each defined as a function of a calibration parameter which defines a common reliability margin of the memory reliability optimization goals.

21-23. (canceled)

24. A data processing apparatus comprising:
flash memory having a plurality of multi-level flash memory cells being arranged in multiple physical pages each having a defined number N>1 of data pages corresponding to the different levels of the multi-level flash memory; and
one or more processors coupled to the flash memory, wherein the one or more processors having access to a program memory in which one or more programs are stored, which when executed on the one or more processors cause the data processing apparatus to perform a method of restructuring input data to be stored in the flash memory comprising:
based on a defined page structure according to which the input data is segmented into multiple logical input pages, restructuring the segmented input data to obtain corresponding output data being segmented into logical output pages, wherein each output page has one or more associated destination data pages for storing content of the output page therein; and
outputting the segmented output data for storage to the flash memory in accordance with the associations between the output pages and their respective destination data pages;
wherein the restructuring comprises:
assigning to each output page a respective corresponding input page, and wherein selecting the respective input page for assignment to the respective output page is based on:
the level of the one or more destination data pages being associated with the output page,
the content of the input page, and
a memory reliability optimization goal defined as a function of the level of the one or more destination data pages being associated with the output page,
wherein the input page is selected so that the input page or a reversibly transformed version thereof satisfies the memory reliability optimization goal associated with the output page's associated one or more destination data pages, and the content of the output page is defined accordingly as that of the input page or its reversibly transformed version, respectively.

25. The data processing apparatus of claim 24, wherein for each output page, selecting the respective corresponding input page comprises determining for each of the input pages a respective associated indicator that characterizes the input page; and
selecting the input page for assignment to the output page comprises:
comparing of the associated respective indicators of multiple input pages with the memory reliability optimization goal related to the level of the one or more destination data pages being associated with the output page, and
determining one input page among the multiple input pages, which itself or the reversibly transformed version thereof satisfies the memory reliability optimization goal, as the selected input page.
